(19) United States
(12) Patent Application Publication
(10) Pub. No.: US 2012/0021323 A1
(43) Pub. Date: Jan. 26, 2012

(54) FUEL CELL AND METHOD FOR PRODUCING THE SAME

(76) Inventors: Gilbert Erdler, Ettlingen (DE); Mirko Frank, Freudenstadt (DE); Holger Reinecke, Emmendingen (DE); Claas Mueller, Freiburg (DE)

(21) Appl. No.: 13/146,775

(22) PCT Filed: Dec. 16, 2009
(86) PCT No.: PCT/EP2009/009011

§ 371 Date: Oct. 11, 2011

(30) Foreign Application Priority Data
Jan. 28, 2009 (DE) 09001158.6

(51) Int. Cl. H01M 8/04; H01M 4/86; H01M 8/24

(52) U.S. Cl. 429/455; 429/514

(57) ABSTRACT

The invention relates to a fuel cell (1) having a substrate (2) comprising an opening (10) and a layer stack (7) disposed on the substrate (2). Said stack comprises an electrode (3) designed as a self-supporting metal membrane covering the opening (10), said membrane being permeable to hydrogen atoms and blocking the passage of gaseous or liquid fuel, a counter electrode (6), and an electrolytelayer (4) adjoining a catalytic material and disposed between the electrode (3) and the counter electrotrode (6). In order to feed in a fuel comprising protons, the fuel cell (1) has a fuel supply device (14) connected to the electrode (3) by means of the opening (10). In order to feed in a reactant, a reactant supply device (15) is connected to the electrolyte layer (4) by means of the counter electrode (6). The reactant is suitable for reacting with the protons in order to generate electric current. The layer thickness of the electrode (3) is at least 1 μm, and the electrode is made of a non-porous material across the entire layer thickness thereof.

The invention relates to a fuel cell, comprising at least
a substrate having at least one opening,
a layer stack disposed on the substrate and comprising at least
   an electrode, formed as a self-supporting metal membrane which covers the opening, is permeable to hydrogen atoms, and blocks the passage of gaseous or liquid fuel,
   a counter electrode, and
   an electrolyte layer which is disposed between the electrode and the counter electrode, is permeable to protons, and is adjacent to a catalytic material,
a fuel supply device, which is connected to the electrode to feed in a proton-containing fuel by means of the opening, and
a reactant supply device, which to feed in a reactant is connected to the electrolyte layer by means of the counter electrode, whereby the reactant is suitable for reacting with the protons for current generation.

A fuel cell of this type is disclosed by EP 1 294 039 A1. The fuel cell has a substrate, which has openings each of which is covered by an electrode. The electrode consists of two layers, namely, a nonporous electrode layer in contact with the substrate and an overlying porous electrode layer. The nonporous electrode layer consists of a hydrogen-permeable material which blocks the reactant and carbon monoxide. The porous layer is gas-permeable. A proton-permeable polymer electrolyte layer is disposed on the porous electrode layer and on the electrolyte layer a porous counter electrode, which is also gas-permeable. The counter electrode consists of a catalytic material, namely, platinum. The polymer electrolyte layer is supplied with hydrogen through the electrode layer via a gas distribution structure. The reactant is supplied to the polymer electrolyte layer via the counter electrode, said reactant which reacts chemically with the protons of the hydrogen and thereby generates an electrical voltage, which can be tapped between the electrode and the counter electrode.

The nonporous electrode layer has a thickness of 0.005 to 0.08 μm and is used to reduce the risk of a so-called poisoning of the fuel cell, for example, when the fuel cell is operated with impure hydrogen. The chemical reaction between the reactant and the protons is inhibited by the poisoning, as a result of which the electrical cell voltage arising between the electrode and the counter electrode is reduced.

The miniaturization of such a fuel cell has been beset thus far with unresolved problems. Because the electrode is pressure-sensitive, the hydrogen is typically supplied to the gas distribution structure via a pressure-reducing valve. With an increasing degree of miniaturization, however, it becomes technologically more costly to fabricate with sufficiently good tolerances the required mechanical components which have movable parts, such as valves and pressure regulators, fittings, and guides. In addition, the assembly of the fuel cell, which consists of a plurality of individual parts during fabrication, becomes increasingly difficult with an increasing degree of miniaturization.

European Pat. Appl. No. EP 1 282 184 A2 discloses a fuel cell, which has a silicon substrate, in which openings are provided, each of which is covered by an electrode. A proton-permeable polymer electrolyte layer is disposed on the electrode and on said electrolyte layer a counter electrode. The polymer electrolyte layer is supplied with hydrogen through the electrode layer via a gas distribution structure. The reactant is supplied by means of the counter electrode. The precise structure of the electrode and the counter electrode is not disclosed, however, in the patent application.

JP 2001 236970 A describes a fuel cell, which has a silicon substrate which has an opening, covered by a layer stack which is disposed on the substrate and has a plurality of laminated layers. The layer stack has an electrode, a counter electrode, and a fixed electrolyte layer between these. On its bottom side, facing away from the electrolyte layer, the electrode is adjacent to the opening, which delimits a first flow-through chamber. The first flow-through chamber has an inlet for oxygen gas, a first inlet for hydrogen gas, and an outlet for oxygen gas and water. The counter electrode is adjacent on its top side, facing away from the electrolyte layer, to a second flow-through chamber, which has a second inlet for hydrogen gas and an outlet for hydrogen gas and water. Because of the flow-through chambers, only relatively low gas pressures occur at the electrode. A disadvantage of this fuel cell is that the inlets and outlets require a relatively complicated structure.

It is therefore the object to create a fuel cell of the aforementioned type, which with compact dimensions enables a simple and cost-effective structure and a high cell voltage.

Said object is attained in that the layer thickness of the electrode is at least 1 μm and that the electrode consists of a nonporous material across its entire layer thickness.

As a result, the fuel cell can be acted upon in an advantageous manner on the side of the electrode, facing away from the electrolyte layer, by a relatively high operating pressure. It is possible thereby to connect the opening, provided in the substrate and adjacent to the electrode, without the interconnection of a pressure regulator and/or valve directly to the fuel supply device, or to apply the fuel gas pressure of the fuel supply device. Thus, the fuel cell can be built completely without movable parts. The fuel cell can be produced cost-effectively with very compact dimensions by process steps known from semiconductor fabrication technology. In addition, the electrolyte layer is sealed from the fuel by the substrate which is impermeable to gaseous and liquid fuel and by the metal membrane covering the opening and impermeable to gaseous fuel, so that only the hydrogen atoms (protons) in the fuel can reach the electrolyte layer. Chemical poisoning of the fuel cell is thus avoided from the outset. Because gaseous fuel is held back from the metal membrane, it cannot be conveyed to the electrolyte layer or conveyed only in a weakened form. The fuel cell of the invention therefore does not require any microstructured flow fields or diffusion layers to supply the starting materials to the electrode or counter electrode. The layer stack consists preferably of three layers, namely, the electrode layer 3, the electrolyte layer 4, and the counter electrode 6.

The substrate is preferably a semiconductor substrate. In this case, it is even possible that an electronic circuit, which is preferably supplied with electrical energy by the fuel cell, is integrated into the substrate in addition to the fuel cell.

In a preferred embodiment of the invention, the layer thickness of the electrode is less than 100 μm. The electrode can then be produced with compact dimensions and good mechanical strength by a standard process in semiconductor manufacture.

In an advantageous embodiment of the invention, at least one first layer stack and a second layer stack are disposed next to one another on the substrate, said stacks between which a space is formed by which the electrodes and the electrolyte layers of the layer stack are spaced apart from one another, whereby the counter electrode of the second layer stack extends up to the space and is connected there in an electrically conducting manner to the electrode of the first layer stack directly or indirectly via a trace. The individual fuel cell electrochemical cells, formed by the layer stack, are therefore connected in series in a simple manner without the use of plated through-holes. The fuel cell can thereby be produced even more cost-effectively.

In a preferred embodiment of the invention, the arrangement formed by the substrate and the at least one layer stack is disposed in such a way in the interior cavity of a housing that it divides the interior cavity into a first chamber and a second chamber separated therefrom, whereby the first chamber has the fuel supply device and the second chamber the reactant supply device. The fuel supply device is then encapsulated by the housing walls adjacent to the first chamber and by the substrate and electrode, so that the provided fuel does not enter the second chamber and can come into contact with the counter electrode and/or the electrolyte layer located there.

In addition, the arrangement formed by the substrate and the at least one layer stack is protected from mechanical damage by the housing.

In an expedient embodiment of the invention, the second chamber has a passage bore whereby the passage bore is covered with a cover made of a porous material permeable to the reactant. This produces a simply structured reactant supply device, in which atmospheric oxygen as the reactant can be fed through the cover into the second chamber.

It is advantageous when the counter electrode is designed as an air diffusion layer, which is permeable to atmospheric oxygen as the reactant. The reactant can then be obtained in a simple manner out of the atmosphere. The air diffusion layer may contain carbon particles whose surface is coated with platinum. In addition, the reaction product arising during the fuel reaction can be discharged outward from the second chamber via the air diffusion layer.

The electrode consists preferably of palladium or a palladium/silver alloy. In this case, hydrogen may be used as the fuel.

The fuel supply device expediently contains a chemical hydride. The hydride is preferably sodium borohydride (NaBH₄). Hydrogen can be released as fuel from the hydride by a catalytic hydrolysis.

In an advantageous embodiment of the invention, the fuel supply device contains at least one hydrocarbon compound, whereby the back of the electrode, facing away from the electrolyte layer, is coated with a catalyst that is in contact with the hydrocarbon compound. The fuel supply device then generates hydrogen catalytically which is used as the fuel for the fuel cell. The hydrocarbon compound can be, for example, methanol, ethanol, or ether. The catalyst may contain platinum and/or ruthenium.

In another expedient embodiment of the invention, the fuel supply device is designed as a zinc-potassium hydroxide cell. A commercially available cell can therefore be used. It is even possible here that the housing of the fuel cell is designed in such a way that the fuel supply device is replaceable.

The counter electrode consists preferably of platinum or a platinum alloy. The counter electrode then also fulfills the function of a catalyst for the chemical reaction between the protons and the reactant.

In a preferred embodiment of the invention, the cross section of the opening narrows, proceeding from the substrate back facing away from the electrode, toward the electrode. The preferably conical bore can then be introduced by anisotropic etching into the substrate during the production of the fuel cell. Gas bubbles of foreign gases, which can enter the bore, for example, during generation of the fuel from methanol during fuel cell operation, are taken away from the electrode due to the surface forces by the conical bore.

The at least one electrolyte layer is preferably formed as a polymer layer, particularly as a polyelectrolyte membrane.

An exemplary embodiment of the invention is described in greater detail hereinafter using the drawing. In the drawing,

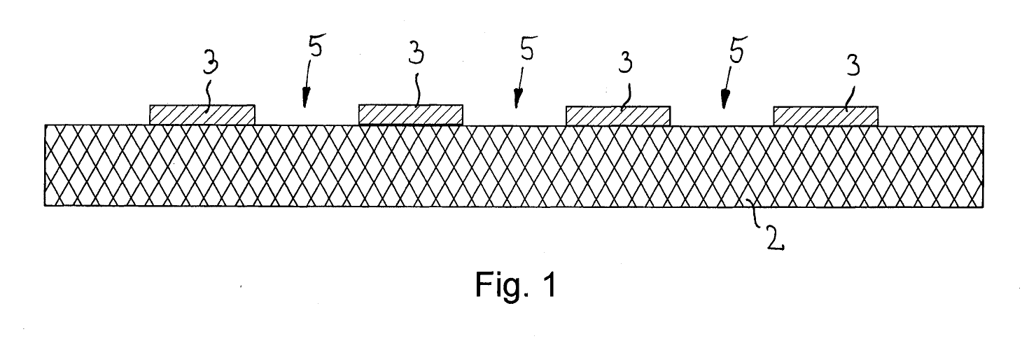

FIG. 1 shows a cross section through a substrate which consists of a semiconductor material and was structured with a plurality of planar electrodes;

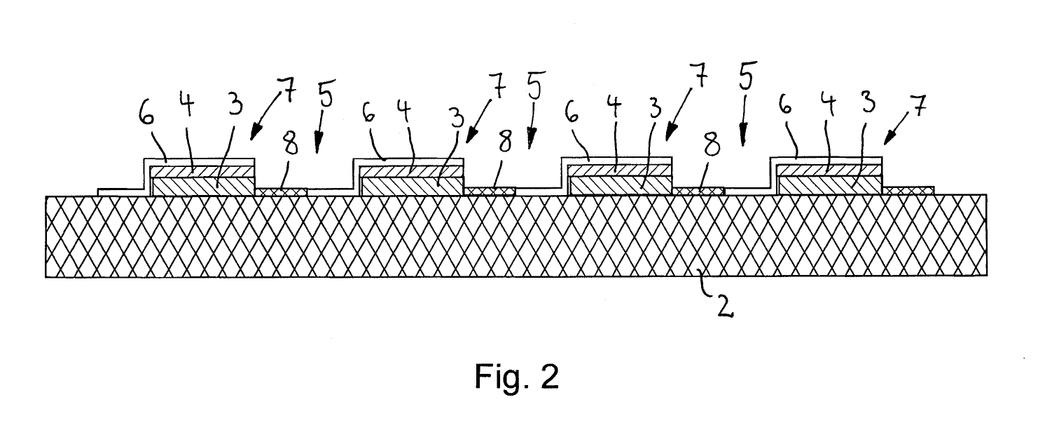

FIG. 2 shows a cross section through the arrangement shown in FIG. 1 after the application of the electrolyte layers, counter electrodes, and conductors to the substrate;

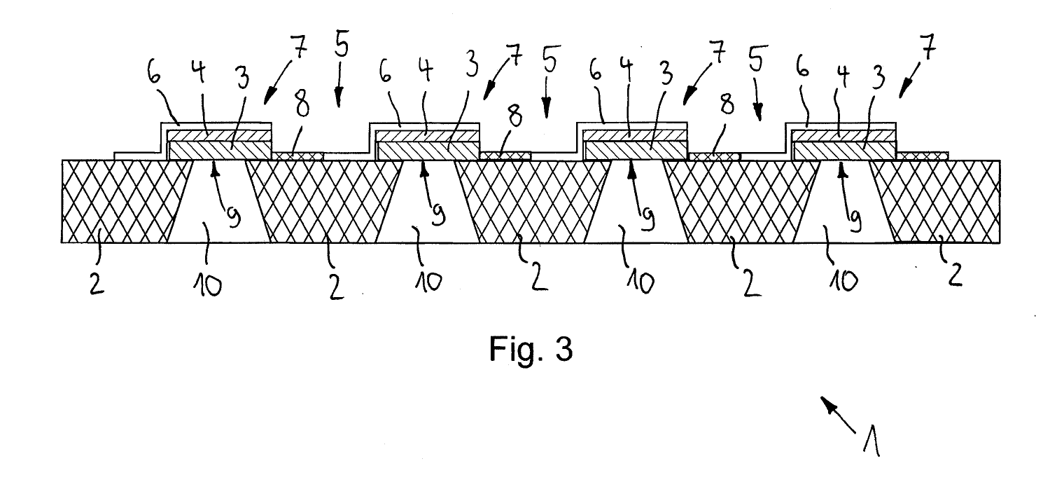

FIG. 3 shows a cross section through the arrangement shown in FIG. 2, after openings were introduced into the substrate on the back; and

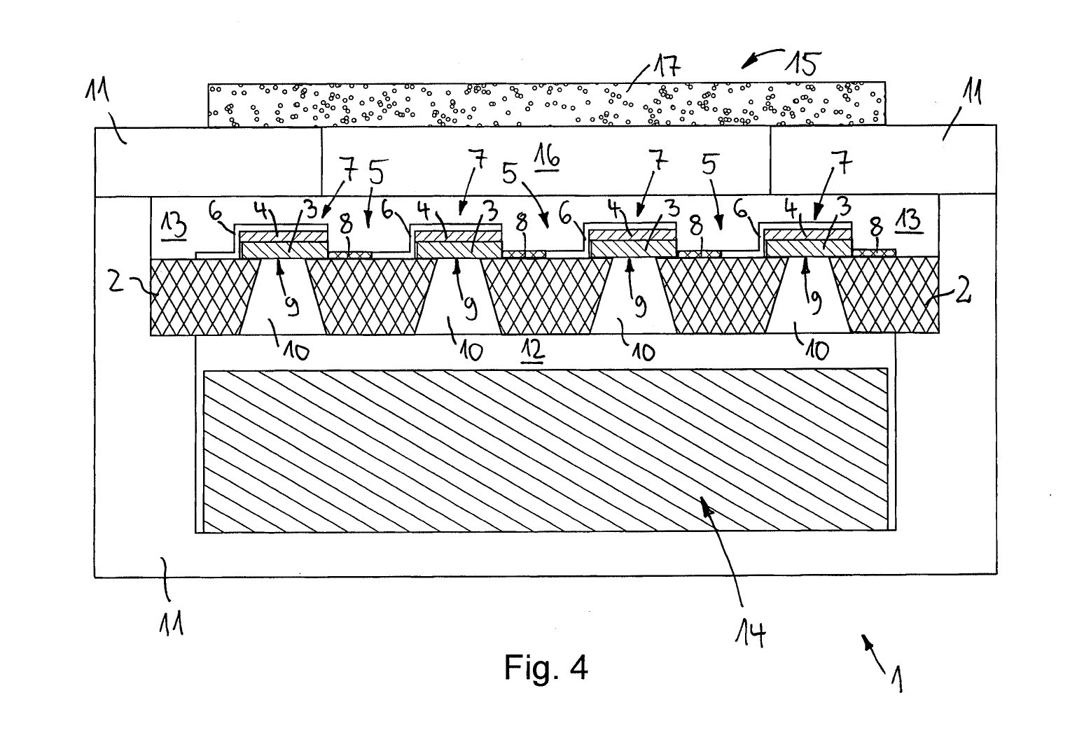

FIG. 4 shows a cross section through the arrangement shown in FIG. 3 after mounting into a housing.

In a method for manufacturing a fuel cell 1, a semiconductor wafer is provided as substrate 2. A thin palladium film or a film of a palladium/silver alloy is applied to substrate 2, for example, with a thickness in the range of 1-10 μm. As can be seen in FIG. 1, the palladium film is structured in such a way that a plurality of planar electrodes 3 is produced, which are spaced apart laterally by spaces 5. Electrodes 3 later form the anodes of fuel cell 1. The layer thickness of electrodes 3 is between 1 μm and 100 μm.

In another process step, a proton-permeable electrolyte layer 4, which is embodied as a polymer electrolyte membrane, is applied to electrodes 3 and substrate 2. Electrolyte layer 4 is structured in such a way that it is arranged substantially only over electrodes 3 and covers their entire surface. It is clearly evident in FIG. 2 that electrode 3 is in planar contact both with electrolyte layer 4 and the substrate.

Electrolyte layer 4 and substrate 2 are now coated in a planar manner with an electrically conducting air diffusion layer, which is permeable to atmospheric oxygen and water. The air diffusion layer is porous and has a plurality of carbon particles, which are coated with a catalytically active material, such as, e.g., platinum or a platinum alloy.

The air diffusion layer is structured in such a way that for each electrode 3 a counter electrode 6 is formed, which is arranged over the relevant electrode 3 and is spaced apart by electrolyte layer 4 transverse to the plane of the wafer of electrode 3. Counter electrodes 6 later form the cathodes of fuel cell 1. It can be seen in FIG. 2 that electrodes 3, the structured electrolyte layer 4, and counter electrodes 6 form a plurality of layer stacks 7, which are arranged next to one another on substrate 2. The individual layer stacks 7 therefore each have three layers, namely, electrode layer 3, electrolyte layer 4, and counter electrode 6.

The counter electrodes are structured so that they project on one side in each case laterally over electrolyte layer 4 and with their projecting subregion cover substrate 2. It can be seen in FIG. 2 that the projecting subregions are each arranged in space 5 to a neighboring layer stack and are connected electrically via a trace 8, provided in space 5, to electrode 3 of the neighboring layer stack 7. The electrochemical cells formed by the individual layer stack 7 are therefore connected electrically in series via traces 8.

In another process step, material is removed at the back of substrate 2, said back facing away from electrodes 3, in such a way that the back surfaces 9 of electrodes 3, said surfaces facing substrate 2, are exposed in areas at a distance to their edges. It can be seen in FIG. 3 that openings 10 are introduced in substrate 2 below electrodes 3 by the material removal and that electrodes 3 cover openings 10. In this case, electrodes 3 with their edge regions without interruption abut the edge of substrate 2, said edge surrounding openings 9, and seal openings 9 gas-tight. The cross section of openings 10 narrows in each case proceeding from the back of substrate 2, said back facing away from electrode 3, conically toward electrode 3.

In another process step, the arrangement, formed by the substrate and layer stack 7, is inserted in the interior cavity of a housing in such a way that it divides the interior cavity into a first chamber 12 and a second chamber 13 separated therefrom. A fuel supply device 14, shown only schematically in the drawing, is disposed in first chamber 12; it has a fuel reservoir and/or a fuel source with a discharge opening for the fuel. The discharge opening to supply the fuel is connected to openings 10. Hydrogen is preferably provided as the fuel.

In the case of contact with the back surfaces 9 of electrodes 3, hydrogen atoms/protons are released from the fuel, and these diffuse through electrode 3 and electrolyte layer 4 to the counter electrode. In this case, electrons are released, which flow over an electric circuit, not shown in greater detail in the drawing, from electrodes 3 to counter electrodes 6.

First chamber 12 has an access element, which is not shown in greater detail in the drawing and can be moved into an open and closed position, and over which fuel supply device 14 can be removed from first chamber 12 and be replaced by a suitable replacement part, when the fuel is consumed.

Atmospheric oxygen is supplied as a reactant to electrolyte layer 4 via the second chamber. Housing 11 for this purpose becomes a reactant supply device 15, which in an outer wall of the housing has an opening 16 and a cover 17 covering said opening. Cover 17 consists of a porous material, which is permeable to the reactant.

The atmospheric oxygen entering through cover 17 into second chamber 13 diffuses through counter electrode 6 to electrolyte layer 4 and there reacts with the protons of the fuel. During the reaction, the electrons reaching the counter electrode via the electric circuit recombine. Water arises as a reaction product, which exits through cover 17 from second chamber 13.

1. A fuel cell, comprising at least
a substrate having at least one opening,
a layer stack disposed on the substrate and comprising at least
an electrode, formed as a self-supporting metal membrane which covers the opening, is permeable to hydrogen atoms, and blocks the passage of gaseous or liquid fuel,
a counter electrode, and
an electrolyte layer which is disposed between the electrode and the counter electrode, is permeable to protons, and is adjacent to a catalytic material,
a fuel supply device, which is connected to the electrode to feed in a proton-containing fuel by means of the opening, and
a reactant supply device, which to feed in a reactant is connected to the electrolyte layer by means of the counter electrode, whereby the reactant is suitable for reacting with the protons for current generation, characterized in that the layer thickness of the electrode is at least 1 μm and that the electrode consists of a nonporous material across its entire layer thickness.

2. The fuel cell according to claim 1, wherein the layer thickness of the electrode is less than 100 μm.

3. The fuel cell according to claim 1 wherein at least one first layer stack and a second layer stack are disposed next to one another on the substrate, said stacks between which a space is formed by which the electrodes and the electrolyte layers of the layer stack are spaced apart from one another, and wherein the counter electrode of the second layer stack extends up to the space and is connected there in an electrically conducting manner to the electrode of the first layer stack directly or indirectly via a trace.

4. The fuel cell according to claim 1, wherein the arrangement formed by the substrate and the at least one layer stack is disposed in such a way in the interior cavity of a housing that it divides the interior cavity into a first chamber and a second chamber separated therefrom, and wherein the first chamber has the fuel supply device and the second chamber the reactant supply device.

5. The fuel cell according to claim 1, wherein the second chamber has a passage bore and that the passage bore is covered with a cover made of a porous material permeable to the reactant.

6. The fuel cell according to any claim 1, wherein the counter electrode is designed as an air diffusion layer, which is permeable to atmospheric oxygen as the reactant.

7. The fuel cell according to claim 1, wherein the electrode consists of palladium or a palladium/silver alloy.

8. The fuel cell according to claim 1, wherein the fuel supply device contains a chemical hydride.

9. The fuel cell according to claim 1, wherein the fuel supply device contains at least one hydrocarbon compound, and that the back of the electrode, said back facing away from the electrolyte layer, is coated with a catalyst that is in contact with the hydrocarbon compound.

10. The fuel cell according to claim 1, wherein the fuel supply device is designed as a zinc-potassium hydroxide cell.

11. The fuel cell according to claim 1, wherein the counter electrode comprises platinum or a platinum alloy.

12. The fuel cell according to claim 1, wherein the cross section of the opening narrows proceeding from the back of the substrate, said back facing away from the electrode, toward the electrode.
